(19) United States
(12) Patent Application Publication
(10) Pub. No.: US 2009/0327307 A1
(43) Pub. Date: Dec. 31, 2009

(54) Personal routine system and method thereof for automatic tracking, automatic recording, and searching of a personal routine

(76) Inventors: Fang-Cheng Sun, Taipei City (TW); Chai-Wang Chang, Jhonghe City (TW); Wei-Kang Lin, Taipei City (TW); An-Chi Lin, Taipei City (TW); Ching-Hua Huang, Banciao City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 12/213,901

(22) Filed: Jun. 26, 2008

(51) Int. Cl. G06F 17/30

(52) U.S. Cl. 707/10; 707/103 R; 707/E17.032

(57) ABSTRACT

A personal routine system that automatically traces and links a users' time, locations and activities. The person routine system includes a position recording unit for recording the user's location information, a routine tracking system having a first mapping module for matching data and files the data with the user's time and location information, and a service platform. The routine tracking system also provides a browse function and a search function for the matched records and transfers them to the service platform. The service platform stores the records transmitted from a second network interface into a second storage unit and uses a user interface to display the records stored in the second storage unit and further provides the browse and search functions.

### BACKGROUND OF THE INVENTION

1. Field of the Invention

The present invention relates to a personal routine system and method thereof, and more particularly to a system and method for automatically tracking a daily routine by combining time with a change of geographic position and recording the resulting data, wherein the data can then be searched.

2. Description of Related Art

Positioning system is applicable for tracing a location or a traveling path of a person or an object, and global positioning systems have been used extensively in the applications of tracking and monitoring staffs or planning a commuting route. However, after the daily routine of a person's location and the time of passing regarding the location are collected, the activities conducted are usually not defined or are only limitedly define by a predetermined method (i.e. package delivered at a certain time: such as tracking the destination of a parcel via courier or confirming an acceptance of the parcel by a recipient's electronic signature), in general the types of activities taken when the staff passes through or stays at a certain location are seldom linked automatically with time and geographic location for data management.

However, in this digital age, in terms of most people's life style, records of personal activity, study, work, or leisure recreation will include files, photos, videotapes, or calendars that are digitally made, modified, and stored by a computer system. The data accumulates in quantity and size as time passes, and general users will have trouble to recall the time or the reason of creating every record, thus a large amount of unused but not deleted data or information is produced, and also a large amount of uncategorized data will clutter the computer system.

Hence, a routine tracking can be used to help users link and manage each file and data in their daily life systematically, so that a user's time, space and activity can be linked automatically to simplify the data management and make the past record remain a clearly defined and valuable memory.

### SUMMARY OF THE INVENTION

Therefore, it is a primary objective of the present invention to provide a personal routine system and method thereof for automatic tracking, automatic recording, and searching of a personal routine; wherein by integrating the tracking of a user's geographic location, along with the various time and tasks or activities respectively conducted at the various locations, in order to facilitate users to remember and in turn to search for a past record effectively.

The system comprises a position recording unit, a routine tracking system, and a network service platform, wherein the routine tracking system further comprises a first storage unit, a first network interface, an operating interface, and a first processing module; the first processing module further comprises a first mapping module; and the network service platform further comprises a second network interface, a second storage unit, and a user interface.

The position recording unit is provided for continuously receiving and recording a series of location data from a positioning system, wherein the location data comprises a date, a time, coordinates and a traveling speed recorded at a particular time. The position recording unit transmits the location data to the routine tracking system, and after the first processing module receives the location data, a first mapping module matches the location data with a file data stored in the first storage unit. The file data shall at least records the date and the time of creating or revising of each file data, and the first mapping module matches each file data and its received location data and link the file data recorded at the same date and time with the coordinates in the location data, so that a user's geographic location at each time point is linked with the user's activity at that time point in order to create a routine record data of the user, and the routine record data is stored in the first storage unit. The operating interface is provided for users to browse the routine record data stored in the first storage unit. In addition, the first network interface is provided for transmitting the routine record data to the network service platform via the Internet.

The network service platform receives the routine record data transmitted from the routine tracking system through the second network interface and stores the data in the second storage unit. A user can connect the network service platform through the network and use the user interface to browse or inquire the routine record data stored in the second storage unit. Wherein a search by location of data created or modified, is known as location oriented inquiry; a search by time of data created or modified, is known as time oriented inquiry; and a search by data information, such as file name, size, and file type is known as data oriented inquiry.

The present invention provides a method for a personal routine tracking system for automatic tracking, automatic recording, and searching of a personal routine, that can be used for linking a user's location data and a file data created or revised by the user to facilitate managing and reviewing the user's location and activities.

The method includes: records a series of location data from a positioning system by a position recording unit; then the position recording unit is connected to a routine tracking system, and the location data is transmitted to the routine tracking system; and a time matching is conducted between the location data and the file data created and revised by users and stored in the routine tracking system, such that the location at the same time point is linked to the data to create a routine record data; and the routine record data can be browsed or inquired through an operating interface.

With the technique and method of the above mentioned system, users no longer need to separately record the association of each file data, furthermore the user's can automatically and systemically link the location of the user's daily routine along with time and activity, which will assist users to manage their data in terms of identification, classification, and organization.

### BRIEF DESCRIPTION OF THE DRAWINGS

FIG. 1 is a schematic view of a structure in accordance with a preferred embodiment of the present invention;

FIG. 2 is a system block diagram in accordance with a preferred embodiment of the present invention;

FIG. 3 is a system block diagram in accordance with another preferred embodiment of the present invention;

FIG. 4 is a system block diagram in accordance with another preferred embodiment of the present invention;

FIG. 5 is a flow chart of a method in accordance with a preferred embodiment of the present invention;

FIG. 6 is a flow chart of a method in accordance with another preferred embodiment of the present invention; and

FIG. 7 is a flow chart of a method in accordance with another preferred embodiment of the present invention.

### DETAILED DESCRIPTION OF THE PREFERRED EMBODIMENTS

The present invention relates to a technology of combining a user's geographic location and time with a file data created at the same time, so that each data combined with the related time and location can provide users several ways of reviewing and inquiring the past data sequentially and systematically.

The technical measures and expected effects of the present invention will become apparent by the detailed description of preferred embodiments together with related drawings as follows.

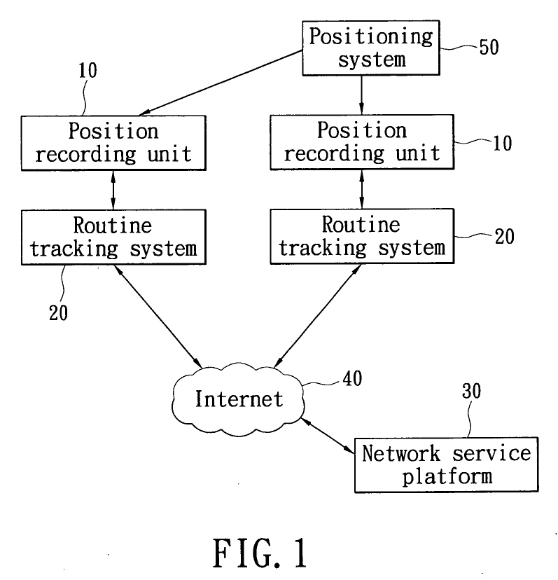

Referring to FIG. 1 for a schematic view of a system structure in accordance with a preferred embodiment of the present invention, a position recording unit 10 is provided for continuously receiving and recording a series of location data transmitted from a positioning system 50, then the position recording unit 10 transmitting the recorded location data to routine tracking system 20, and then matching the location data with a user's file data via the routine tracking system 20, and the routine tracking system 20 creating a routine record data of the user. In addition to the function of browsing or searching a routine record data from the routine tracking system 20, users can transmit the routine record data to a network service platform 30 via Internet 40 and browse, inquire or share a user's routine record data on the network service platform 30.

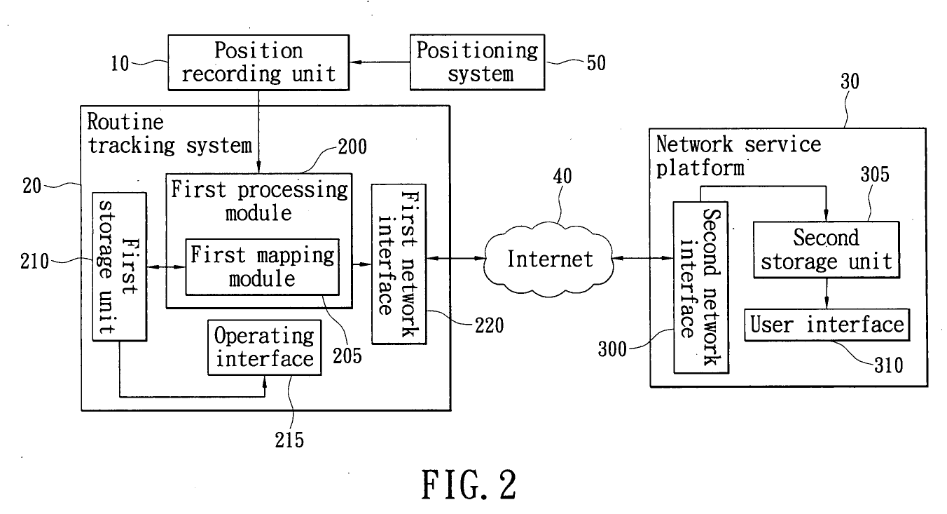

Referring to FIG. 2 for a system block diagram in accordance with a preferred embodiment of the present invention, the position recording unit 10 in this embodiment is a personal track recorder (PTR) for continuously receiving and recording a series of location data transmitted from the positioning system 50, and the positioning system 50 in this embodiment is a global positioning system (GPS), and each location data includes a time, the date at the time, coordinates of the position recording unit 10 at that time, and a traveling speed at that time; furthermore the data recorded in each location data are linked with a user's passing route or located position within a certain period of time.

The position recording unit 10 transmits a series of recorded location data to a first processing module 200 of the routine tracking system 20 after the position recording unit 10 is connected to the routine tracking system 20, and the first processing module 200 instructs a first mapping module 205 to compare the received location data against the various files, pictures, audios, videos or schedules created or modified and saved into a first storage unit 210 by a user. The location data is matched with the user's data (i.e. user data's creation time or modified time), and the coordinates of the user's location is combined with a document or file data created or modified at the same date and time, so that each recorded time and coordinate is associated with one or more file data created by the user. T he associated location data and the file data stored in the first storage unit 210 forms a routine record data. The routine tracking system of this embodiment uses an operating interface 215 for browsing the routine record data in the first storage unit 210 or inquiring certain specific information in the routine record data through the operating interface 215.

Furthermore, the first processing module 200 can use a first network interface 220 to transmit the routine record data to the network service platform 30 via the Internet 40. The network service platform 30 also has a second network interface 300 for communicating with the data on the Internet 40 and receiving the routine record data transmitted from the routine tracking system 20. After the network service platform 30 receives the data, the network service platform 30 stores the data into a second storage unit 305 of the network service platform 30, and a user interface 310 is provided for users to browse or access the routine record data on the network service platform 30.

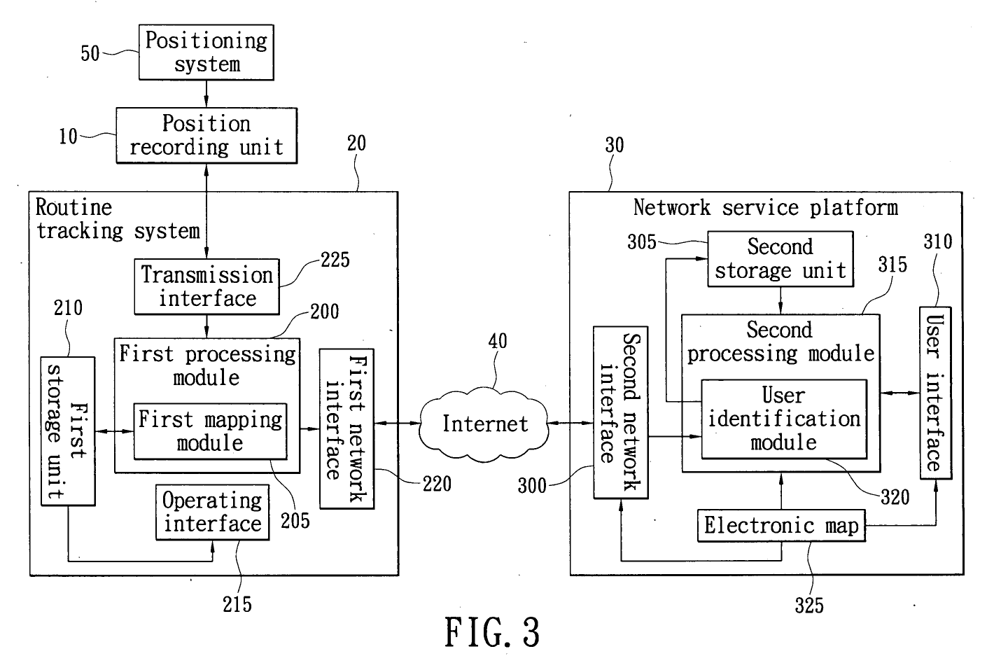

Referring to FIG. 3 for a system block diagram in accordance with another preferred embodiment of the present invention, the position recording unit 10 receives a series of location data from the positioning system 50 and transmits the recorded location data to the first processing module 200 via the transmission interface 225 after connecting with the routine tracking system 20. The first processing module 200 transfers the location data to the first mapping module 205 to match with the file data in the first storage unit 210 in order to obtain the created or modified file data to match against the coordinates of a location and the traveling speed recorded according to the date and time (i.e. compare the date and time of the file data with the data and time associated when the location coordinates and traveling speed are recorded), so that each matched data is combined to create a routine record data, and the routine record data is stored in the first storage unit 210.

The routine tracking system 20 further provides an operating interface 215 for users to input other commands, and the commands are used for processing the routine record data such as transmitting the routine record data to the network service platform 30, and also used for browsing or inquiring the routine record data stored in the first storage unit 210; and furthermore the operating interface 215 allows users to input a command of setting to the position recording unit 10 such as specifying the frequency for the position recording unit 10 to record the location data. In this embodiment, a time interval (such as once every second, 10 seconds or 60 seconds) between a maximum range (such as 1˜240 seconds) is used for specifying the frequency for the position recording unit 10 to receive information from the positioning system 50. In the embodiment, the operating interface 215 can further receives an input of a command to automatically overwrite the setting data or turn on/off the position recording unit 10.

After the operating interface 215 receives the input of the foregoing command, the command is transmitted to the first processing module 200, and the first processing module 200 sets or changes the connected position recording unit 10 and transmits the updated setting to the position recording unit 10 through the transmission interface 225, such that the position recording unit 10 can record the location data according to the new setting or transmitting the routine record data to the network service platform 30 by the first network interface 220 according to a user's instruction.

The network service platform 30 uses the second network interface 300 to communicate with routine record data transmitted via the Internet 40. In this embodiment, after the second network interface 300 receives a user's routine record data, the second processing module 315 lets a user identification module 320 determine the identification of a user who transmits the schedule data, and the identification is determined by a user account, and the data transmitted by the user is classified, and the user identification module 320 stores each received routine record data into the second storage module 305 according to different users/accounts. Users can browse and inquire their own routine record data from the user interface 310 provided by the network service platform 30, after the user identification module 320 has identified a correct account or password. In addition, users can also share their routine record data, so that other users can browse or inquire the routine record data. The second processing module 315 reads the data in the second storage unit 305 according to the browse or inquire command of the user interface 310, and the second processing module 315 transmits the data to the user interface 310 for the display.

Regarding the browsing and searching of data provided by the user interface 310, the data includes the time associated with a certain geographic location of the user personal routine, wherein both the time and the location are displayed on a map; and also included in the data is the user's activity at the time such as creating a document or taking a picture, etc. To achieve the foregoing objective, the network service platform 30 of this embodiment further provides an electronic map 325 for converting coordinates data into a physical geographic location. If a user selects to browse a routine record data in the form of a map, the second processing module 315 will read the routine record data in the second storage unit 305 and convert the recorded coordinates of a location into a physical geographic location on the electronic map 325 and transmit the data to the user interface 310, so that the user interface 310 can display the time when the user or another user is situated at each location on a map and the file created at that location (i.e. search by location of data created or modified, also known as location oriented inquiry; search by time of data created or modified, also known as time oriented inquiry; and lastly search by data information, such as file name, size, file type is known as data oriented inquiry).

The electronic map 325 is linked to the routine tracking system 20 of each user through the second network interface 300, such that users can convert the coordinates in the first storage unit 210 into a physical geographic location on the electronic map 325 in order to browse the routine record data of the users in a map on the operating interface 215 through the first processing module 200.

The browsed or inquired result provided by the operating interface 215 or the user interface 310 is not limited to the form of a map, but text or voice can be used for expressing the result. Since the date, time, and various different file information in each routine record data are correlated, therefore the routine record data can be browsed or inquired based on the inquiring location against the data, or based on a specific time or a specific location of the inquired data, or based on a specific date or data inquired at a specific location, or based on the type of users. The user's route can be played or displayed continuously in different ways according to a time sequence. The first processing module 200 and the second processing module 320 read the corresponding routine record data according to the received browse or inquire command and display the routine record data according to the command respectively.

Users can use different equipments such as a computer, a mobile phone or a personal digital assistant (PDA) to connect the Internet in order to use the aforementioned browse, inquire, share or other functions of the network service platform 30.

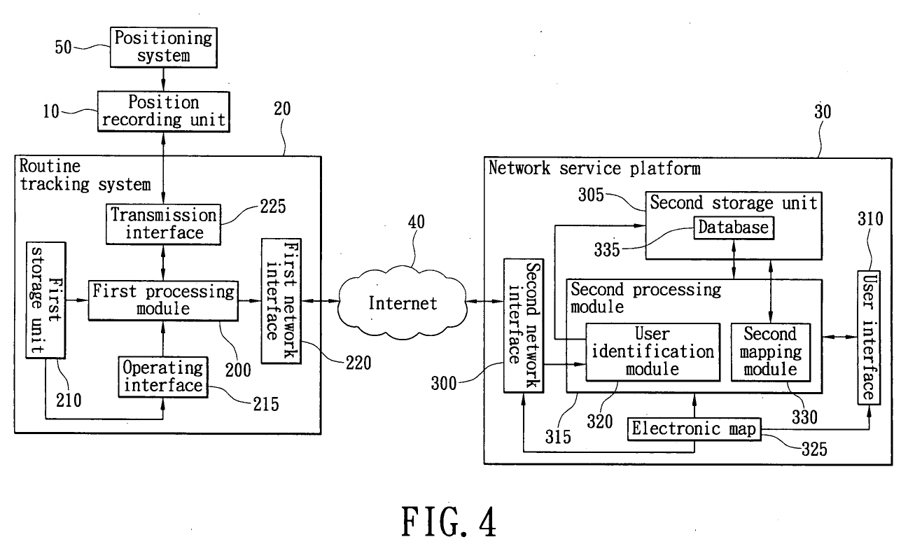

In addition to the association of the location data with the data in the routine tracking system 20 to create a routine record data, the present invention can also upload the data to the network service platform 30 for the aforementioned matching operation as shown in FIG. 4 and described below.

After the position recording unit 10 is connected to the routine tracking system 20, the location data is transmitted to the first processing module 200 of the routine tracking system 20 via the transmission interface 225, and the first processing module 200 transmits the received location data to the network service platform 30 through the first network interface 220. The related user's file and data stored in the first storage unit 210 are transmitted altogether or separately to the network service platform 30 through the first network interface 220 by the command from the first processing module 200.

After the network service platform 30 receives a user's location data and file data, the second processing module 315 transfers the data to the user identification module 320 according to different users/accounts and stores each received routine record data into the second storage module 305. The second processing module 315 reads the user's location data and the file data previously stored in the second storage unit 305, and instructs the second mapping module 330 for the matching (i.e. matching of time stamp between location data and file data, or matching of geographic location created of location data and file data), so that the user's location data and the file data are associated to create a routine record data. After the data are matched, users can operate at the network service platform 30, make use of the user identification module 320 to identify a correct account or password, and use the user interface 310 provided by the network service platform 30 to search the routine record. A user can display the results according to a way specified by the user (i.e. such as previous mentioned way of “both the time and the location are displayed on a map”, or the traditional text display, or display by voice). The ways for the electronic map 325 and the user interface 310 to display the browsed or inquired result have been described in the aforementioned preferred embodiment and illustrated in FIG. 3, and thus will not be described here again.

Further, users can share their settings through the user interface 310 to open up a part or the whole of their routine record data for other users. The second processing module 315 records a user's shared setting into a database 335 of the second storage unit 305, such that when other users want to inquire or browse the routine record data of a specific user, the shared setting stored in the database 335 is compared to determined whether or not other users can access the routine record data of that particular user.

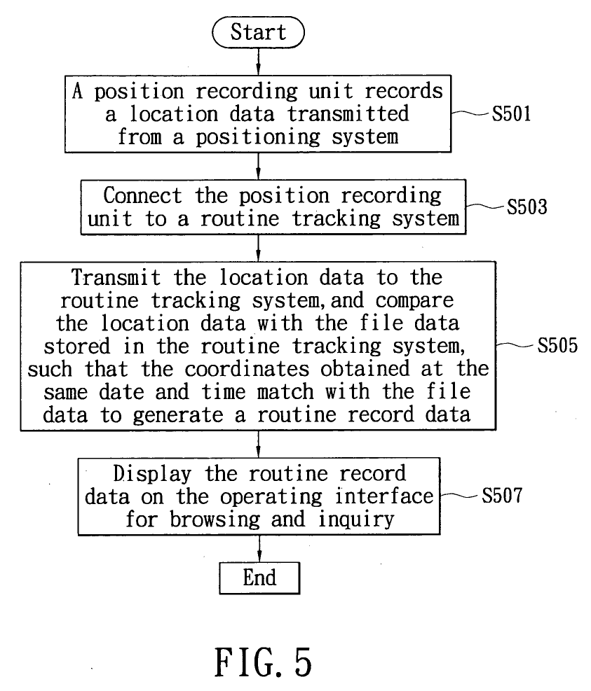

Referring to FIG. 5 for a flow chart of the method of the present invention, a position recording unit 10 records a location data transmitted from a positioning system 50 (S501), wherein the location data includes a date, a time, coordinates and a traveling speed recorded at a particular time. After the position recording unit 10 is connected to a routine tracking system 20 (S503), the location data is transmitted to the routine tracking system 20 and compared with the file data stored in the routine tracking system 20, such that the coordinates obtained at the same date and time match with the file data to create a routine record data (S505), and the routine record data is displayed on the operating interface 215 for browsing and inquiry (S507).

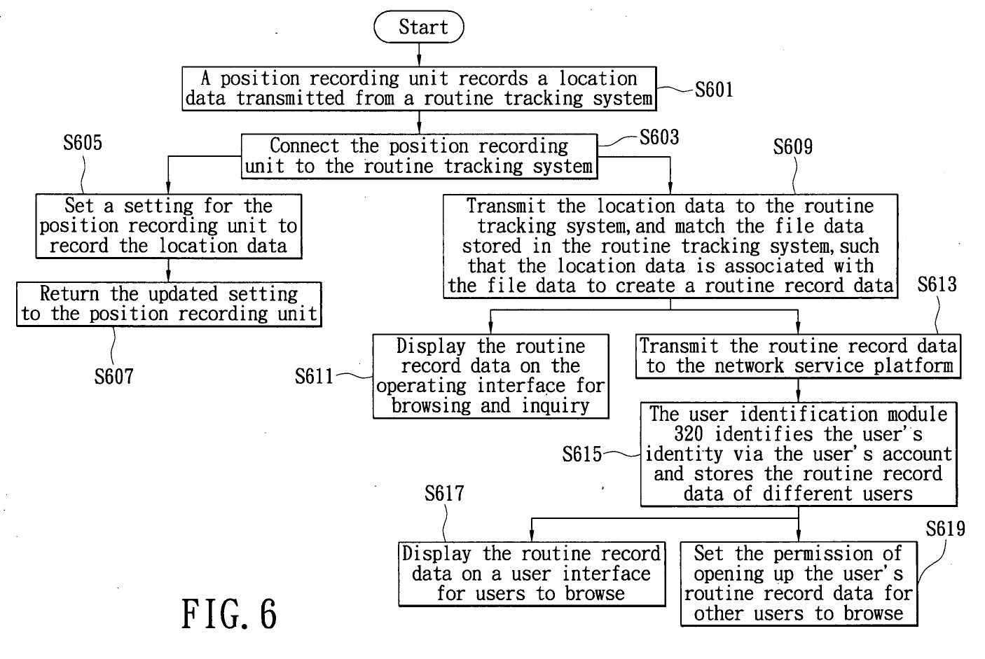

Referring to FIG. 6 for a flow chart of a method in accordance with another preferred embodiment of the present invention, the position recording unit 10 of this embodiment records a location data (S601), and after the routine tracking system 20 is connected (S603), a setting for the position recording unit 10 to record the location data is adjusted (S605) by the first processing module 200 according to a command input from the operation interface 215, and the setting includes changing the recording frequency and setting an automatic ON/OFF the recording, etc. and a modified setting is transmitted back to the position recording unit 10 (S607) from the first processing module 200 so that the modified settings can be initiated.

After the position recording unit 10 is connected to the routine tracking system 20, the aforementioned coordinates and file data can be matched (i.e. matched by time stamp of file creation or geographic location of file creation) to create a routine record data (S609), and the routine record data is displayed on the operating interface 215 for browsing and inquiry (S611). After the routine record data is created (S609), the routine record data can be transmitted to the network service platform 30 via the Internet (S613), and the user identification module 320 in the network service platform 30 identifies the user's identity via the user's account and stores the routine record data of different users into the second storage unit 305 (S615), and displays the stored routine record data through a user interface 310 (S617), or sets the permission of opening up the user's routine record data for other users to browse (S619).

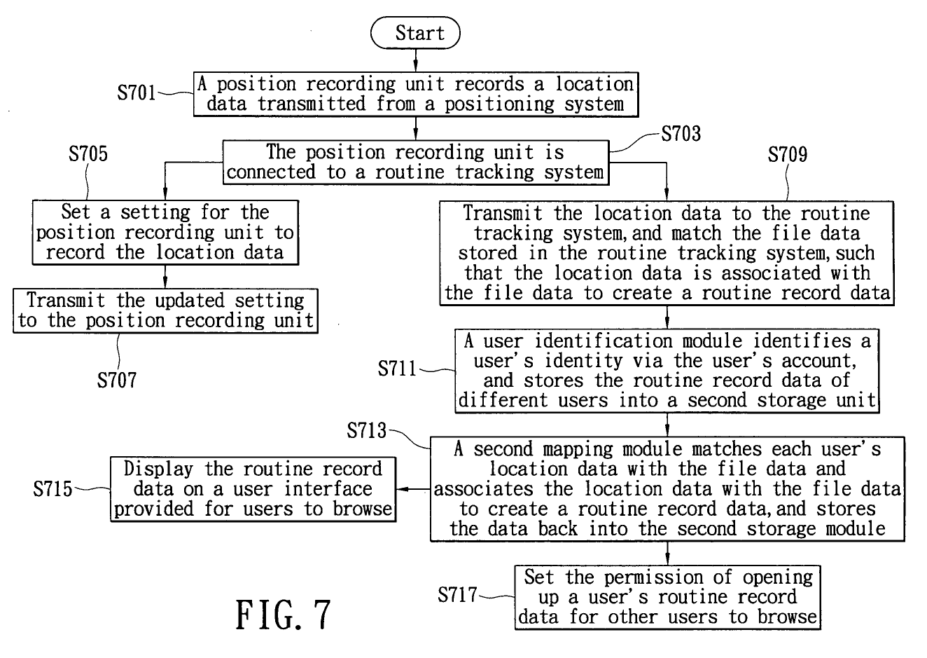

Referring to FIG. 7 for a flow chart of a method in accordance with another preferred embodiment of the present invention, the difference of this embodiment from the previous embodiment illustrated in FIG. 6 resides on that this embodiment displays the user's data on the network service platform 30 according to the following flow. Steps S705 and S707 of this embodiment correspond to Steps S605 and S607 of the previous embodiment respectively, and thus will not be described here again.

A position recording unit 10 records a location data from a positioning system 50 (S701), and after the position recording unit 10 is connected to a routine tracking system 20 (S703), the location data is transmitted to the routine tracking system 20, and the routine tracking system 20 transmits a file or data stored in the first storage unit 210 of the system 20 and the location data to a network service platform 30 (S709). After a user identification module 320 of the network service platform 30 identifies a user's identity via the user's account, the routine record data of different users are stored in a second storage unit 305 (S711), and the second processing module 315 instructs a second mapping module 330 to match each user's location data with the file data and associate the location data with the file data to create a routine record data, and stores the data back into the second storage module 305 (S713). Finally, a user interface 310 is provided for displaying the stored routine record data (S715) or setting the permission of opening up a user's routine record data for other users to browse (S717).

Although the present invention has been described with reference to the preferred embodiments thereof, it will be understood that the present invention is not limited to the details thereof. Various substitutions and modifications made by those of ordinary skill in the art are intended to be embraced within the scope of the invention as defined in the appended claims.

What is claimed is:

1. A personal routine system for automatic tracking, automatic recording, and searching of a personal routine, comprising:
a position recording unit, for continuously recording and receiving at least one location data from a positioning system, and the recorded location data including a date, a time and coordinates recorded at the recording time;
a routine tracking system, comprising:
a first storage unit, for storing at least one file data, and the recorded file data including the date and time for producing and revising the file data;
a first processing module, for processing the file data and the location data stored in the first storage unit, and the first processing module further comprising:
a first mapping module, for matching the location data received by the first processing module with the file data stored in the first storage unit, such that the coordinates at the same date and time are associated with the file data to form a routine record data, and storing the routine record data in the first storage unit;
an operating interface, provided for browsing or inquiring a routine record data stored in the first storage unit; and
a first network interface, provided for the first processing module to transmit the routine record data stored in the first storage unit to the Internet.

2. The personal routine system of claim 1, wherein the operating interface is provided for receiving and processing the routine record data or setting a command of the position recording unit.

3. The personal routine system of claim 2, wherein the first processing module is used for analyzing and processing a command received by the operating interface, and processing the routine record data or setting the position recording unit according to the content of the command.

4. The personal routine t system of claim 3, wherein the routine tracking system further comprising:
a transmission interface, connecting the position recording unit and the first processing module, the transmission interface is for transmitting the location data recorded by the position recording unit to the first mapping module, wherein the first mapping module matching the location data with the file data, and the transmission interface is also for transmitting an updated setting back to the position recording unit, wherein the updated setting is generated by the first processing module according to the command received by the operating interface.

5. The personal routine system of claim 1, further comprising:
a network service platform, for receiving and processing the routine record data transmitted through the first network interface, and the network service platform further comprising:
a second network interface, provided for the network service platform to receive the routine record data transmitted from the first network interface;
a second storage unit, for storing the received routine record data;
a second processing module, for accessing and processing the routine record data stored in the second storage unit; and
a user interface, provided for a user to browse, inquire or set the routine record data stored in the second storage unit from the network service platform.

6. The personal routine system of claim 5, wherein the first network interface transmits the location data transmitted from the first processing module and the file data to the network service platform and stores both of the data in the second storage module.

7. The personal routine system of claim 6, wherein the second processing module further comprising:
a second mapping module, for matching the file data stored in the second storage module against the location data, such that the coordinates at the same date and time of the same user are associated with the file data to produce a routine record data, and the routine record data is stored in the second storage unit.

8. The personal routine system of claim 5, wherein the second processing module further comprising:
a user identification module, for determining whether or not the data received by the second network interface is a different user's data via a user's account, and storing the routine record data into the second storage unit according to different users.

9. The personal routine system of claim 7, wherein the second processing module further comprising:
a user identification module for determining whether or not the data received by the second network interface is a different user's data via a user's account, and storing the routine record data into the second storage unit according to different users.

10. The personal routine system of claim 5, wherein the network service platform further comprising:
an electronic map provided for the second processing module to display each routine record data corresponding to a physical geographic location according to the coordinates, and display the file data in the form of a map associated with the geographic location for a user to browse the file data from the user interface or use the second network interface to transmit the file data to the Internet.

11. The personal routine system of claim 1, wherein the positioning system is a global positioning system.

12. The personal routine system of claim 3, wherein the first processing module sets a recording frequency of the position recording unit, determines whether or not to update the data automatically, or determines whether or not to turn on the system automatically.

13. The personal routine system of claim 10, wherein the electronic map is linked to the Internet and to the routine tracking system through the second network interface, and the first processing module displays the routine record data stored in the first storage unit in the form of a map according to the command received by the operating interface and the linked electronic map.

14. The personal routine system of claim 5, wherein the second storage unit further comprising:
a database for recording the second processing module according to the command received by the user interface, and setting the permission of opening up each routine record data for other users to browse.

15. The personal routine system of claim 5, wherein the user interface is provided for performing a time oriented, a data oriented, or a location oriented inquiry, and the inquired result is displayed in form of a text, a voice, or a map.

16. A method for a personal routine system for automatic tracking, automatic recording, and search of a personal routine, comprising the steps of:
(a) recording at least one location data by a position recording unit, wherein the location data includes a date, a time and coordinates recorded at a particular time;
(b) connecting the position recording unit and a routine tracking system;
(c) transmitting the location data to the routine tracking system, and matching a file data stored in the routine tracking system for associating the coordinates measured at the same date and time with the file data to create a routine record data; and
(d) displaying the routine record data on an operating interface.

17. The method of claim 16, wherein the Step (c) adjusts the setting of the position recording unit, and the Step (d) returns an updated setting to the position recording unit.

18. The method of claim 16, wherein the Step (d) transmits the routine record data to a network service platform.

19. The method of claim 16, wherein the Step (c) transmits the location data to the routine tracking system, and transmits a file data stored in the location data and the routine tracking system to a network service platform; and the Step (d) matches the location data with the file data by a second mapping module of the network service platform, such that the coordinates at the same date and time of the same user are associated with the file data to produce a routine record data.

20. The method of claim 18, further comprising a procedure after the Step (d), and the procedure comprising the steps of:
(e) identifying a user's identity via the user's account, and storing the routine record data of different users; and
(f) displaying the routine record data on a user interface.

21. The method of claim 19, further comprising a procedure after the Step (d), and the procedure comprising the steps of:
(e) identifying a user's identity via the user's account, and storing the routine record data of different users; and
(f) displaying the routine record data on a user interface.

22. The method of claim 20, wherein Step (f) sets a permission of opening up a user's routine record data for other users to browse.
